(19) United States
(12) Patent Application Publication
(10) Pub. No.: US 2014/0240996 A1
(43) Pub. Date: Aug. 28, 2014

(54) Luminaire arrangement

(71) Applicant: KONINKLIJKE PHILIPS N.V., EINDHOVEN (NL)

(72) Inventor: Henricus Marie Peeters, Baarlo (NL)

(21) Appl. No.: 14/347,400

(22) PCT Filed: Oct. 1, 2012
(86) PCT No.: PCT/IB12/55253

§ 371 Date: Mar. 26, 2014

Related U.S. Application Data
(60) Provisional application No. 61/545,293, filed on Oct. 10, 2011.

(51) Int. Cl. F21K 99/00

(52) U.S. Cl. CPC F21K 9/30
USPC 362/382

(57) ABSTRACT

There is provided a luminaire arrangement (30) comprising a luminaire holder (10) and a luminaire module (20). The luminaire holder (10) is arranged to be attached to a ground plane (32) and comprises electrical circuitry connectors (12), grommet seals (14) provided on said electrical circuitry connectors (12), and a shield (18). The luminaire module (20) comprises a covering (24) and is arranged to be received in the luminaire holder (10). The shield (18) and the covering (24) are arranged to form a sealing arrangement between the luminaire holder (10) and the luminaire module (20), when the luminaire module (20) is received in the luminaire holder (10).

### FIELD OF THE INVENTION

The present invention relates to the field of luminaire modules and in particular to a luminaire arrangement consisting of a luminaire holder and a luminaire module. More particularly, the present invention relates to the field of LED driven luminaire modules.

### BACKGROUND OF THE INVENTION

An increasing number of LED driven luminaires are on the market today. Many of these systems are equipped with LED modules, which comprise a plurality of light emitting diodes, LEDs. The LED module is typically inserted or mounted in a lamp holder.

The industry and other actors in this area are currently cooperating with the aim of developing standard specifications for the interfaces of LED light engines. An LED light engine is an LED module with defined interfaces that do not depend on the type of LED technology used inside the light engine. For example standard specifications for mounting and electrically connecting LED modules may define the electrical, mechanical and also thermal interfaces and enable interchangeability between products made by diverse manufacturers. In other words, this allows customers to interchange LED modules of brand A with brand B. In this way there is no need to exchange sockets or luminaires when a customer wants to replace an LED module.

The interchangeability is achieved by defining interfaces for a variety of application-specific light engines. The standard speciafications may cover the physical dimensions, as well as the photometric, electrical and thermal behavior of LED light engines.

The lighting standards can be implemented in many areas: lighting for homes, retail, offices and also outdoor applications. In many of these applications there is often a requirement for high Ingress Protection, IP. The IP rating classifies and rates the degrees of protection provided against the intrusion of solid objects (including body parts like hands and fingers), dust, accidental contact, and water in mechanical casings and electrical enclosures. The IP rating standard aims to provide more detailed information than vague marketing terms such as waterproof.

One disadvantage of the standards discussed above is that the interface does not incorporate ingress protection. Therefore it is entirely up to the manufacturer of the Luminaire to provide the IP protection when making the design. Further, it is often difficult to realize high IP rating without making a bulky design. In addition, another disadvantage is that extra light loss will occur because the LED module must be fully enveloped by an ingress protective cover.

For these types of applications, where such lighting standards are implemented, there is therefore a need for a compact and easy solution of how to realize an LED Luminaire having both high IP rating and optimal luminaire efficiency.

### SUMMARY OF THE INVENTION

In view of the above it is desirable to provide a luminaire arrangement that can facilitate interchangeability between different brands of luminaire modules and luminaire holders. It is also desirable to provide a luminaire arrangement having high IP protection abilities, while maintaining optimal luminaire efficiency, thus avoiding extra light loss.

In addition, it is desirable to provide a luminaire arrangement that can incorporate high ingress protection without making a bulky design.

Generally, the above objectives are achieved by arrangements and devices according to the attached independent claims.

It is an objective of the current invention to provide an arrangement which solves or at least mitigates the issues addressed above.

According to a first aspect of the invention, this and other objects are achieved by a luminaire arrangement comprising a luminaire holder being arranged to be attached to a ground plane and comprising electrical circuitry connectors, grommet seals provided on said electrical circuitry connectors, and a shield, and a luminaire module comprising a covering and being arranged to be received in said luminaire holder, wherein said shield and said covering are arranged to form a sealing engagement between said luminaire holder and said luminaire module, when said luminaire module is received in said luminaire holder.

Advantageously such a luminaire arrangement may provide an improved interface between a luminaire module and luminaire holder. In this way, the disadvantages of the standards are removed. In other words, the luminaire arrangement according to the present invention incorporates ingress protection in such a way that a watertight protection is formed once the luminaire module is inserted into the luminaire holder.

Another advantage of the inventive luminaire arrangement is that high ingress protection may be achieved in a small and compact design. There is therefore no need for the luminaire builder to make a bulky design by adding an additional cover in order to achieve high IP rating.

The main element of the invention is that the lamp holder, or the luminaire holder, takes care of a watertight connection between ground plane and lamp holder and the watertight connection of the mains wires. For this purpose a shield is added to the lamp holder. The LED module, or the luminaire module, is fitted with an extra skirt. The skirt and shield form a watertight protection once the LED module is inserted in the holder. The skirt does not block or cover the light emitting opening of the LED module. In this way a watertight luminaire can be built with an optical efficiency of 100%. No additional cover is needed. An element of the present invention is that part of the Ingress protection is realized in the lamp holder and part in the interface between lamp holder and LED module. It is also possible to achieve compatibility between low IP rated and high IP rated luminaire holder and luminaire module. The Ingress protection is provided by a skirt being attached to the LED module and by protective rings being mounted onto the lamp holder/socket. Further, three rubber seals can be used to make a watertight interface: a sealing ring between the shield on the luminaire holder and a ground plane; grommet like seals on the cable entry and an O-ring between the skirt on the LED module and the shield on the luminaire holder.

In an embodiment, the luminaire arrangement may further comprise a seal positioned between the shield and the ground plane, the seal being arranged to form a sealing engagement between the luminaire arrangement and the ground plane.

In this way, the luminaire holder, comprising the shield, takes care of the Ingress protected, or watertight, connection between the ground plane and the luminaire holder.

In an embodiment, the luminaire arrangement may comprise a light emitting aperture and the sealing engagement between the luminaire holder and the luminaire module may be formed such that the light emitting aperture remains uncovered, when the luminaire module is received in the luminaire holder.

In this way, the luminaire module, through its covering, and the luminaire holder, through its shield, both take care of the watertight protection once the luminaire module is inserted into the luminaire holder.

In an embodiment the luminaire module may be a light emitting diode module, LED module, comprising a plurality of light emitting diodes.

In an embodiment, at least one gasket, or a so called O-ring, may be attached to the shield of the luminaire holder. This embodiment may naturally further improve the IP rating.

In another embodiment, at least one gasket may be attached to the covering of the luminaire module, whereby the IP rating also may be further improved.

In an embodiment, the covering on the luminaire module may be an integrated covering arrangement comprising the covering and at least one gasket. In this way, the number of required components may be significantly reduced.

In an embodiment, when the luminaire arrangement comprises a seal positioned between the shield and the ground plane, the shield on the luminaire holder may be an integrated shield arrangement comprising the grommet seals, the seal, and at least one gasket.

In yet another embodiment of the luminaire arrangement, at least one gasket may be arranged between the luminaire holder and the ground plane.

In another embodiment, at least one gasket may be attached to the ground plane.

According to a second aspect of the invention, the above object and other objects are achieved by a luminaire holder being arranged to be attached to a ground plane and comprising electrical circuitry connectors, grommet seals provided on said electrical circuitry connectors, and a shield, said luminaire holder being arranged to form part of a luminaire arrangement according to any of the embodiments of the first aspect of the present invention.

According to a third aspect of the invention, the above object and other objects are achieved by a luminaire module being arranged to emit light through a light-emitting aperture and to be received in a luminaire holder and comprising a covering, said luminaire module being arranged to form part of a luminaire arrangement according to any of the embodiments of the first aspect of the present invention.

In an embodiment, the luminaire module may be arranged to be received in a luminaire holder according to the second aspect of the invention.

In another embodiment, the luminaire holder may be arranged to receive a luminaire module according to the third aspect of the present invention.

It is noted that the invention relates to all possible combinations of features recited in the claims. Thus, all features and advantages of the first aspect likewise apply to the second and third aspects, respectively.

### BRIEF DESCRIPTION OF THE DRAWINGS

The various aspects of the invention, including its particular features and advantages, will be readily understood from the following detailed description and the accompanying drawings, in which:

FIG. 1 is a schematic top view of a prior art luminaire holder;

FIG. 2 is a schematic top view of a prior art luminaire module;

FIG. 3 is a schematic side view of a prior art luminaire holder;

FIG. 4 is a schematic side view of a prior art luminaire module;

FIG. 5 is a schematic top view of a luminaire holder according to an embodiment of the present invention;

FIG. 6 is a schematic top view of a luminaire module according to an embodiment of the present invention;

FIG. 7 is a schematic bottom view of a luminaire holder according to an embodiment of the present invention;

FIG. 8 is a schematic side view of a luminaire holder according to an embodiment of the present invention;

FIG. 9 is a schematic side view of a luminaire module according to an embodiment of the present invention;

FIGS. 10-12 illustrate luminaire arrangements according to embodiments of the present invention.

### DETAILED DESCRIPTION

The present invention will now be described more fully hereinafter with reference to the accompanying drawings, in which currently preferred embodiments of the invention are shown. The present invention may, however, be embodied in many different forms and should not be construed as limited to the embodiments set forth herein; rather, these embodiments are provided for thoroughness and completeness, and to fully convey the scope of the invention to the skilled addressee. Like reference characters refer to like elements throughout.

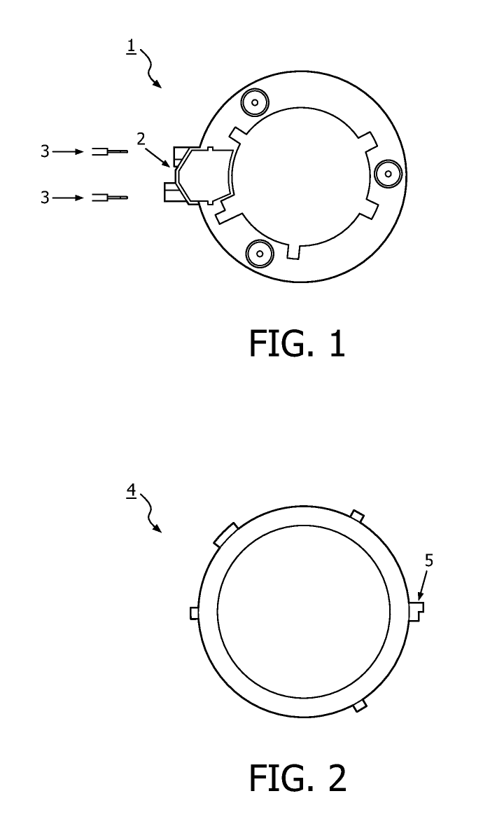

FIG. 1 is a schematic top view of a prior art luminaire holder 1 comprising an electrical circuitry connector 2, to which mains cables 3 can be connected.

FIG. 2 is a schematic top view of a prior art luminaire module 4, comprising a mains connection 5. The luminaire module 4 can be arranged to be received in the prior art luminaire holder 1 illustrated in FIG. 1.

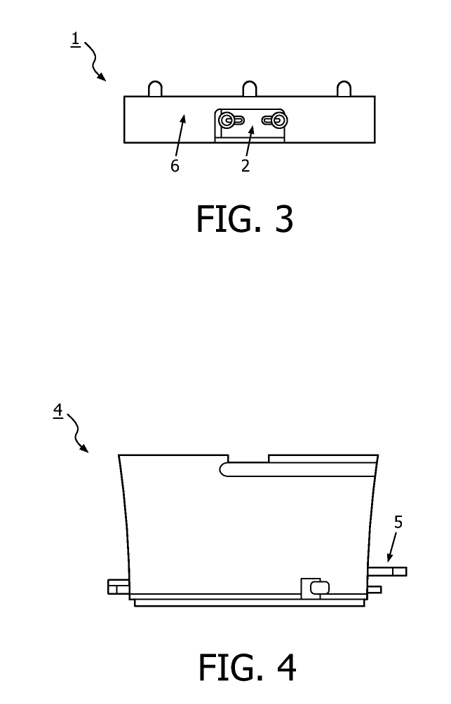

FIG. 3 is a schematic side view of the prior art luminaire holder 1 illustrated in FIG. 1. In FIG. 3 it can be seen that the prior art luminaire holder 1 comprises a base 6, upon which an electrical connector 2 can be attached.

FIG. 4 is a schematic side view of the prior art luminaire module 4 comprising a mains connection 5.

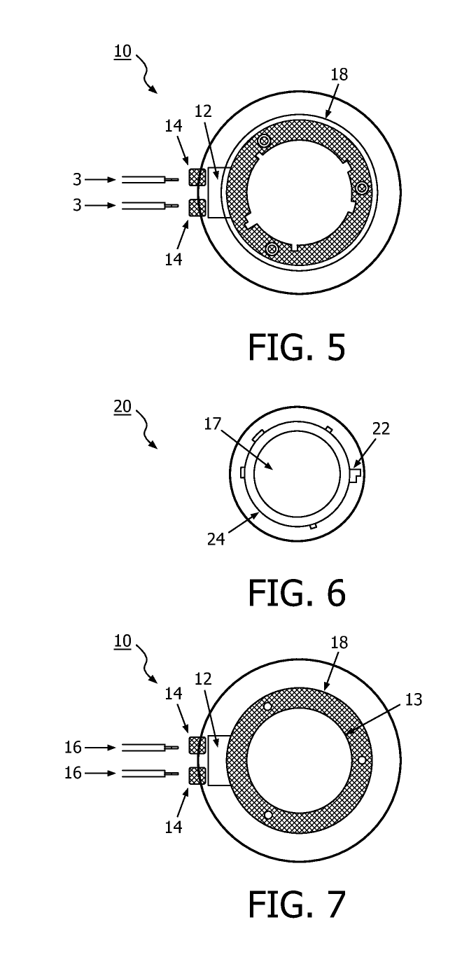

FIG. 5 is a schematic top view of a luminaire holder 10 according to the present inventive concept. The luminaire holder 10 comprises an electrical circuitry connector 12 upon which grommet seals 14 may be provided. The grommet seals 14 allow for a watertight connection of the mains wires 16. The luminaire holder 10 further comprises a shield 18, which can be arranged around the luminaire holder 10. The luminaire holder 10 can further be arranged to be attached to a ground plane.

FIG. 6 is a schematic top view of a luminaire module 20 according to the present inventive concept. The luminaire module 20 comprises an electrical connector 22 and a light emitting aperture 17. The luminaire module further comprises a covering 24. The covering 24 can be arranged around the luminaire module like a skirt.

FIG. 7 is a schematic bottom view of the luminaire holder 10. The luminaire holder 10 comprises a seal 13 arranged between the luminaire holder 10 and a ground plane to which the luminaire holder 10 can be attached. The seal 13 can be positioned between the shield 18 and the ground plane. The luminaire holder 10 can further comprise at least one other seal arranged on the seal 13. The at least one other seal can be a flat rubber ring which can provide a watertight interface between the luminaire holder 10 and the ground plane.

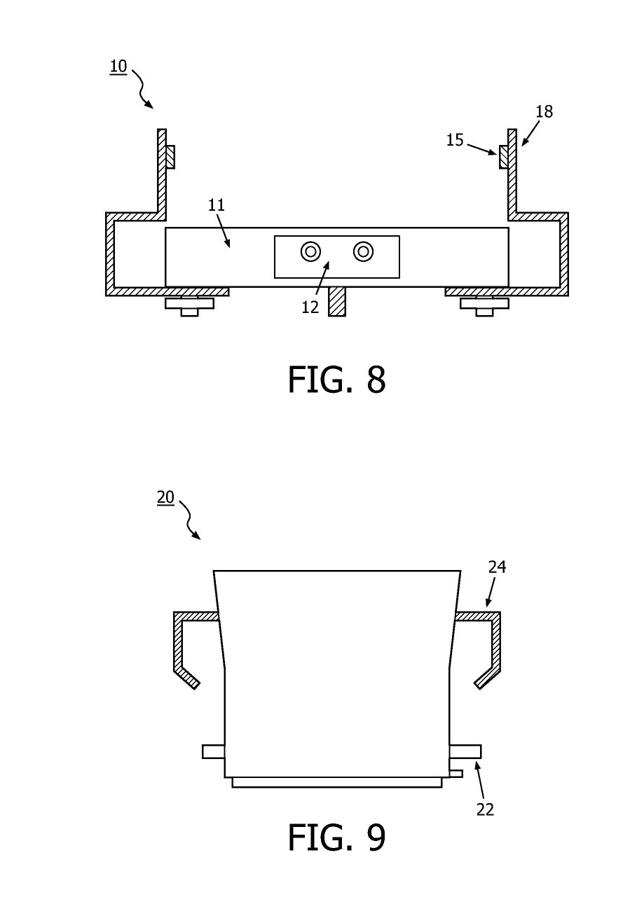

FIG. 8 is a schematic side view of the luminaire holder 10. The luminaire holder 10 comprises a base 11 upon which an electrical circuitry connector 12 is arranged. The luminaire holder 10 further comprises a shield 18 upon which a gasket 15 can be arranged. The gasket can be an O-ring. The luminaire holder 10 can also comprise grommet seals 14 arranged on the mains connector allowing for a watertight connection of the mains wires.

Generally, the luminaire holder is able to connect the luminaire module to the mains supply.

FIG. 9 is a schematic side view of the luminaire module 20. The luminaire module 20 comprises a covering 24, which can be arranged around the luminaire module 20 like a skirt. The luminaire module 20 further comprises an electrical connector 22.

The luminaire module can be a light emitting diode module, LED module, comprising a plurality of light emitting diodes.

Advantageously, the luminaire module can have an integrated driver, removing the need to connect an additional LED driver to it.

The luminaire module may have different color temperatures, for example 2700K, 3000K, 4000K, which all may be dimmable.

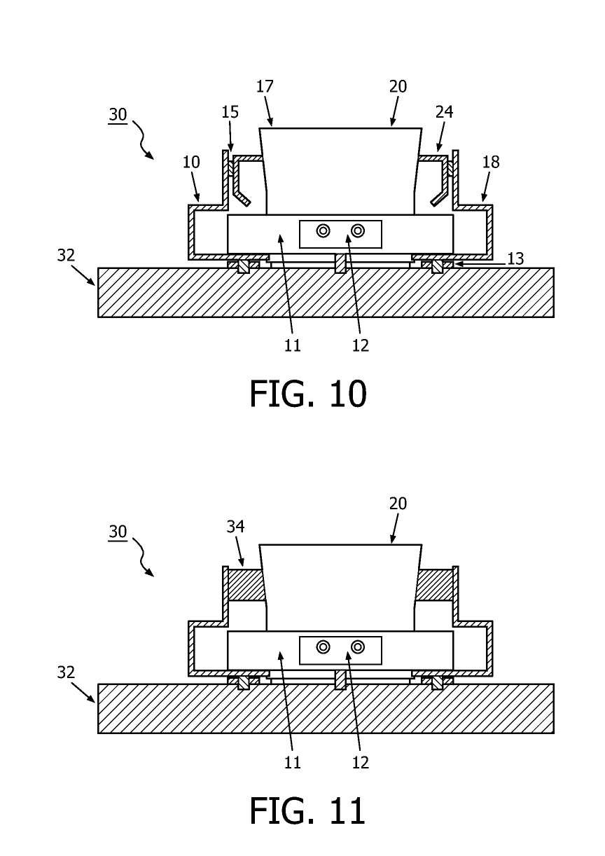

FIG. 10 is a schematic side view of an embodiment of a luminaire arrangement 30 according to the present inventive concept. The luminaire arrangement 30 comprises a luminaire holder 10, like the one illustrated in FIG. 8, and a luminaire module 20, like the one illustrated in FIG. 9. The luminaire holder 10 comprises a base 11 upon which an electrical circuitry connector 12 is arranged. The luminaire holder 10 further comprises a shield 18 arranged on the base 11. The luminaire module 20 comprises a covering 24. The shield 18 and the covering 24 are arranged to form a sealing engagement between the luminaire holder 10 and the luminaire module 20, when the luminaire module 20 is received in the luminaire holder 10.

Further, the luminaire module 20 comprises a light emitting aperture 17. The covering 24 is arranged such that the sealing engagement between the luminaire holder 10 and the luminaire module 20 is formed in a way so that the light emitting aperture remains uncovered, when the luminaire module 20 is received in the luminaire holder 10. This enables a sealing engagement with high Ingress protection whilst at the same time avoiding extra light loss.

To continue, the gasket 15 can be arranged either on the covering 24 or on the shield 18. The gasket 15 further improves the sealing engagement between the luminaire holder 10 and the luminaire module 20, when the two are connected together.

The luminaire arrangement 30 shown in FIG. 10 further comprises a seal 13 positioned between the shield 18 and a ground plane 32. The seal 13 can be arranged to form a sealing engagement between the luminaire arrangement 30 and the ground plane 32. In this way, the luminaire arrangement takes care of a watertight connection between the luminaire holder 10 and the ground plane.

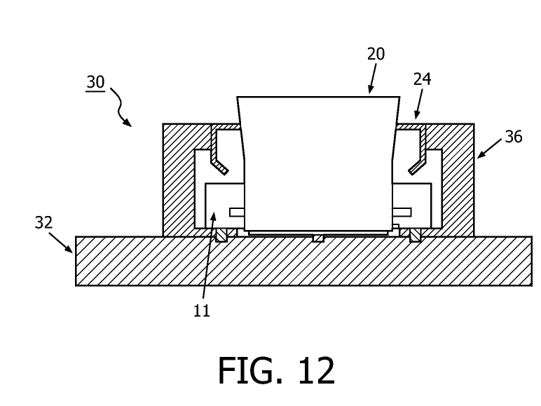

The following embodiments of the present invention that will be described in relation to FIGS. 11 and 12 are in most aspects similar to the above described embodiment in FIG. 10. Only differences will be discussed in the following.

FIG. 11 is a schematic side view of an embodiment of a luminaire arrangement 30 according to the present inventive concept. In this embodiment, the covering 24 on the luminaire module 20 is an integrated covering arrangement 34 comprising the covering and at least one gasket 15. In this embodiment, the integrated covering arrangement 34 is a rubber skirt placed around the luminaire module 20.

FIG. 12 is a schematic side view of an embodiment of a luminaire arrangement 30 according to the present inventive concept. In this embodiment, the shield on the luminaire holder is an integrated shield arrangement 36 comprising the grommet seals 14, the seal and at least one gasket.

According to an embodiment, the at least one gasket can be arranged between the luminaire holder 10 and the ground plane 32.

According to another embodiment, the at least one gasket can be attached to the ground plane 32.

The luminaire holder 10 can as previously described be arranged to be attached to the ground plane 32 and to comprise electrical circuitry connectors 12, grommet seals 14 provided on the electrical circuitry connectors 2, and a shield 18. The luminaire holder 10 can be arranged to form part of a luminaire arrangement 30, as described above in relation to FIGS. 10-12.

The luminaire module 20 can as previously described be arranged to emit light through a light-emitting aperture and to be received in a luminaire holder 20 and to comprise a covering 24. The luminaire module 20 can be arranged to form part of a luminaire arrangement 30 as described above in relation to FIGS. 10-12.

The luminaire module 20 according to the present inventive concept can be arranged to be received in a prior art luminaire holder 1.

A prior art luminaire holder 1 can be arranged to receive a luminaire module 20 according to the present inventive concept.

In this way, it may be possible to combine high IP rated modules with low IP rated holders, and vice versa.

Further, a luminaire can comprise an arrangement 30 according to any one of the luminaire arrangements described above in relation to FIGS. 10-12. Such a luminaire can comprise the ground plane 32 and the luminaire holder 10. In addition, such a luminaire can optionally have more parts, such as covers or rings to integrate and mount the luminaire onto for example a ceiling or a wall. When such a luminaire is assembled in a factory, it is not necessarily required that either the ground plane or the luminaire holder comprises such protective rings. Therefore, separate protective rings could optionally be used when assembling the luminaire.

In summary there has been disclosed a luminaire arrangement 30 comprising a luminaire holder 10 and a luminaire module 20. The luminaire holder 10 is arranged to be attached to a ground plane 32 and comprises electrical circuitry connectors 12, grommet seals 14 provided on said electrical circuitry connectors 12, and a shield 18. The luminaire module 20 comprises a covering 24 and is arranged to be received in the luminaire holder 10. The shield 18 and the covering 24 are arranged to form a sealing arrangement between the luminaire holder 10 and the luminaire module 20, when the luminaire module 20 is received in the luminaire holder 10.

The person skilled in the art realizes that the present invention by no means is limited to the preferred embodiments described above. On the contrary, many modifications and variations are possible within the scope of the appended claims. For example, the disclosed arrangement may be part of a LED light source. Thus, a LED light source may comprise one or more arrangements as disclosed above. Similarly, the disclosed arrangement may be part of a luminaire.

1. A luminaire arrangement comprising
a luminaire holder being arranged to be attached to a ground plane and comprising electrical circuitry connectors, grommet seals provided on said electrical circuitry connectors, and a shield arranged around the luminaire holder, and
a light-emitting diode module comprising a plurality of light emitting diodes and being arranged to be received in said luminaire holder and comprising a covering arranged around the light emitting diode module like a skirt,
wherein said shield and said covering are arranged to form a sealing engagement between said luminaire holder and said light emitting diode module, when said light emitting diode module received in said luminaire holder.

2. The luminaire arrangement according to claim 1,
further comprising a seal positioned between said shield and said ground plane, said seal being arranged to form a sealing engagement between said luminaire arrangement and said ground plane.

3. The luminaire arrangement according to claim 1, wherein said light emitting diode module is comprising a light-emitting aperture and wherein said sealing engagement between said luminaire holder and said light emitting diode module is formed such that said light-emitting aperture remains uncovered, when said light emitting diode module is received in said luminaire holder.

4. (canceled)

5. The luminaire arrangement according to claim 1, wherein at least one gasket is attached to said shield.

6. The luminaire arrangement according to claim 1, wherein at least one gasket is attached to said covering.

7. The luminaire arrangement according to claim 6, wherein said covering on said light emitting diode module is an integrated covering arrangement comprising said covering and at least one gasket.

8. The luminaire arrangement according to claim 2, wherein said shield on said luminaire holder is an integrated shield arrangement comprising said grommet seals said seal, and at least one gasket.

9. The luminaire arrangement according to claim 8, wherein at least one gasket is arranged between said luminaire holder and said ground plane.

10. The luminaire arrangement according to claim 9, wherein at least one gasket is attached to said ground plane.

11. A luminaire holder being arranged to be attached to a ground plane and comprising electrical circuitry connectors, grommet seals provided on said electrical circuitry connectors, and a shield arranged around the luminaire holder,
said luminaire holder being arranged to form part of a luminaire arrangement according to claim 10.

12. A light emitting diode module being arranged to emit light through a light-emitting aperture and to be received in a luminaire holder and comprising a covering arranged around the light emitting diode module like a skirt,
said light emitting diode module being arranged to form part of a luminaire arrangement according to claim 10.

13. A light emitting diode module being arranged to be received in a luminaire holder according to claim 11.

14. A luminaire holder being arranged to receive a light emitting diode module according to claim 12.

15. A luminaire comprising an arrangement according to claim 10.
